(19) United States
(12) Patent Application Publication
(10) Pub. No.: US 2006/0140381 A1
(43) Pub. Date: Jun. 29, 2006

(54) Method and apparatus for segmenting communication network customers into service tiers

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/025,399

(22) Filed: Dec. 29, 2004

(51) Int. Cl. H04M 7/00

(52) U.S. Cl. 379/220.01

(57) ABSTRACT

The present invention enables a capability to identify high spending, or high tier, customers of packet-switched network services, e.g., VoIP network services and provide them with a higher level of service than lower paying, or normal tier, customers. For example, these highly valued customers can be offered free trials or special promotions of new service features and their calls into customer care can always be routed to live, highly experienced customer care agents.

The present invention relates generally to communication networks and, more particularly, to a method and apparatus for segmenting communication network, e.g., Voice over Internet Protocol (VoIP) network, customers into service tiers.

### BACKGROUND OF THE INVENTION

Customers that spend more money with a provider are more valuable from a business perspective than those that spend less. Treating all customers the same can lead to dissatisfaction among those who spend more than other customers.

Therefore, a need exists for a method and apparatus for segmenting communication network customers, e.g., Voice over Internet Protocol (VoIP) network customers into service tiers.

### SUMMARY OF THE INVENTION

In one embodiment, the present invention enables a capability to identify high spending, or high tier, customers of VoIP network services and provide them with a higher level of service than lower paying, or normal tier, customers. For example, these highly valued customers can be offered free trials or special promotions of new service features and their calls into customer care can always be routed to live, highly experienced customer care agents.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of segmenting VoIP network customers into service tiers of the present invention;

FIG. 3 illustrates a flowchart of a method for segmenting VoIP network customers into service tiers of the present invention;

FIG. 4 illustrates a flowchart of a method for handling VoIP network customers based on service tiers of the present invention; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

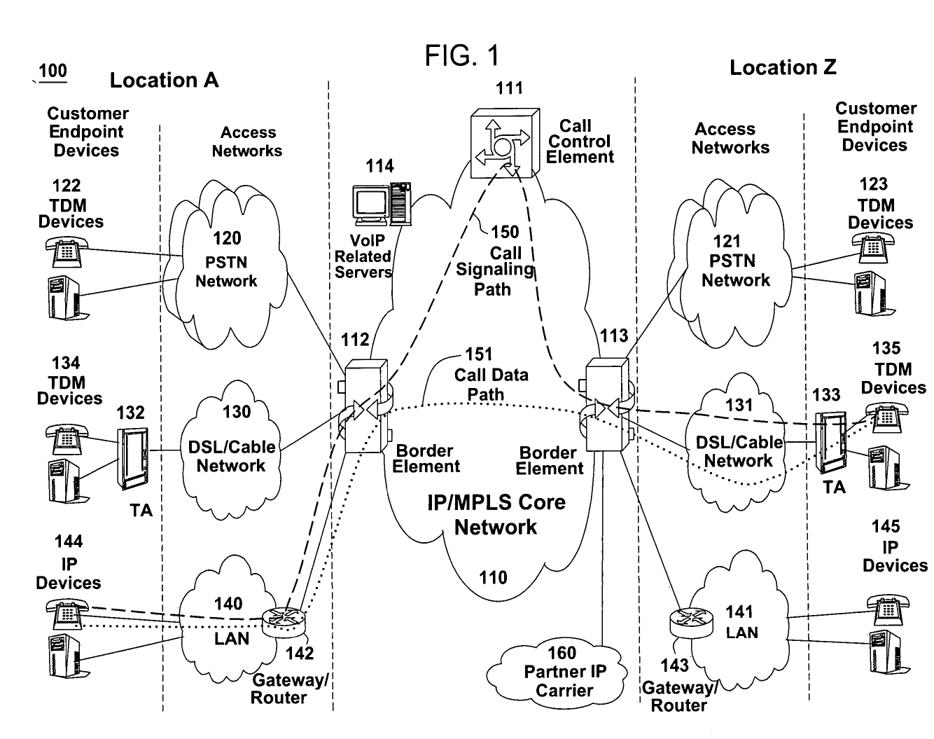

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122,123,134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120,121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP- ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Customers that spend more money with a provider are more valuable from a business perspective than those that spend less. Treating all customers the same can lead to dissatisfaction among those who spend more. Special treatments may be given to the higher paying customers as extra loyalty incentives to retain them.

To address this need, the present invention enables a capability to identify high spending, or high tier, customers of VoIP network services and provide them with a higher level of service than lower paying, or normal tier, customers. For example, these highly valued customers can be offered free trials or special promotions of new service features and their calls into customer care can always be routed to live, highly experienced customer care agents.

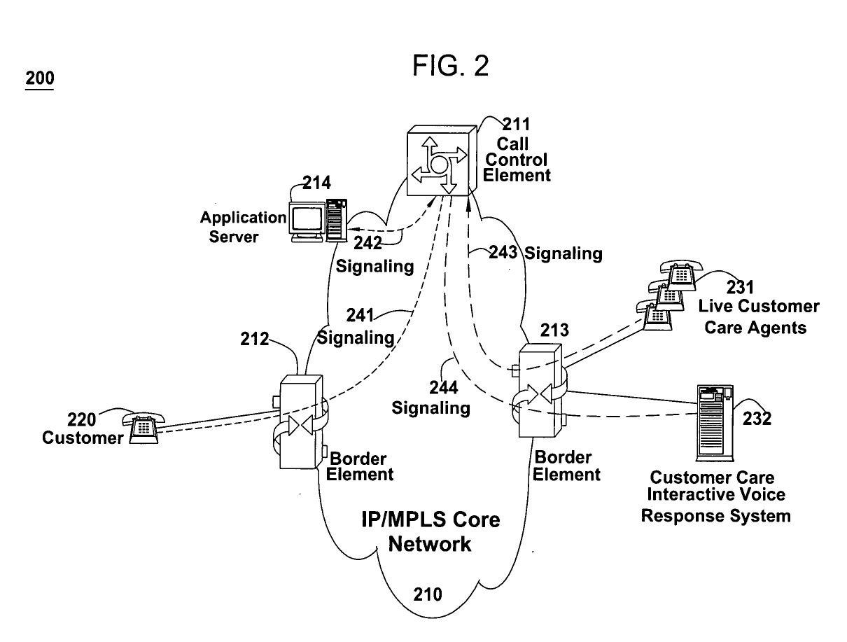

FIG. 2 illustrates an example of segmenting packet-switched network customers, e.g., VoIP network customers, into service tiers. In FIG. 2, a customer 220 is calling the network provider's customer care number to request service related support. CCE 211 receives a call setup message 241 via BE 212 from the customer. CCE 211 communicates with Application Server (AS) 214, flow 242, and finds out that the calling customer is a high tier customer. The tier of a customer is determined by the revenue derived from the customer and the network operator can define a threshold in terms of dollars when such a threshold is exceeded, where the customer is classified as a high tier customer. Other customers whose spending are below such defined threshold are classified as normal tier customers. CCE 211 then forwards the call from a high tier customer to a live customer care agent 231 via BE 213 using signaling flow 243 instead of signaling flow 244, which will forward the call of a normal tier customer to an Interactive Voice Response (IVR) system 232, if the calling customer is a normal tier customer.

Alternatively, if the customer calls other phone numbers, CCE 211 can present new service options to the calling customer before continuing the call setup procedures. For instance, CCE 211 can periodically relay new service feature or free trial offers only available to high tier customers during the call setup process. After the customer accepts or denies the offer, CCE 211 then continues to complete the call setup process to the called party number.

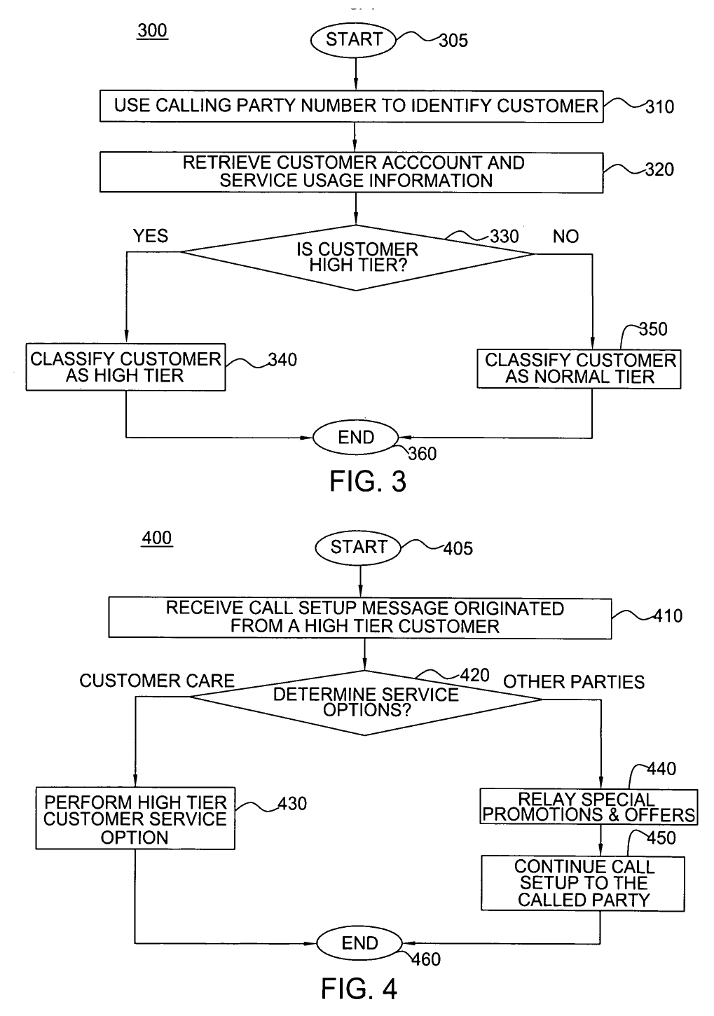

FIG. 3 illustrates a flowchart of a method for segmenting VoIP network customers into service tiers. Method 300 starts in step 305 and proceeds to step 310. The method can be used by the CCE or the AS to determine the service tier of a customer.

In step 310, the method uses the calling party number to identify a customer. In step 320, the method retrieves the customer account and service usage information. In step 330, the method determines if the calling customer is in the high tier or not by using the retrieved account and service usage information. In one embodiment, the tier of a customer is determined by the revenue derived from the customer and the network operator can define a threshold in terms of dollars when such a threshold is exceeded, where the customer is classified as a high tier customer. Other customer whose spending is below such defined threshold is classified as a normal tier customer. If the retrieved account and service usage data exceeds certain predefined threshold, the customer is considered as a high tier customer. If the retrieved account and service usage data exceeds the predefined threshold, the method proceeds to step 340; otherwise, the method proceeds to step 350. In step 340, the method classifies the calling customer a high tier customer. In step 350, the method classifies the calling customer a normal tier customer. The method ends in step 360.

FIG. 4 illustrates a flowchart of a method for handling high service tier network customers, e.g., VoIP network customers by a CCE. Method 400 starts in step 405 and proceeds to step 410.

In step 410, the method receives a call setup message from a high service tier customer, which has been determined by method 300 as discussed above. In step 420, the method determines the service options to be used depending on the called party number. If the call is destined to the customer care services, the method proceeds to step 430; otherwise, the method proceeds to step 440. In step 430, the method provides the high tier customer service option for the call. For instance, the network can always forward the high tier customer call to live customer care agents rather than to an IVR system. In another instance, customer service agents may handle the call differently for a high tier customer from a normal tier customer. If the a higher tier customer is late paying a bill, the customer service agent may automatically extend a longer grace period to the high tier customer. In step 440, the method periodically relays special promotions or offers, such as new service feature or special service price plans, to the calling customers via pre-recorded announcements. After the customer accepts or skips the offers, the method proceeds to step 450. In step 450, the method continues the call setup procedures to the called party number. The method ends in step 460.

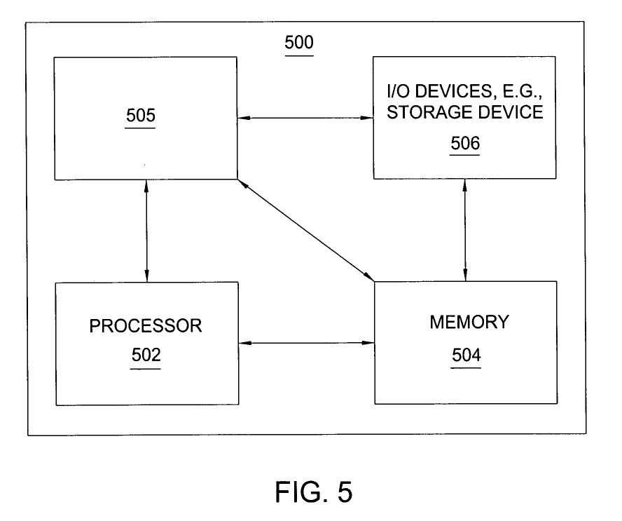

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), a segmenting customers into service tiers module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present segmenting customers into service tiers module or process 505 can be loaded into memory 504 and executed by processor 502 to implement the functions as discussed above. As such, the present segmenting customers into service tiers process 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for segmenting customers into service tiers in a communication network, comprising:
receiving a call setup message for a call from a calling party;
determining a service tier type for said calling party; and
processing said call setup message in accordance with said service tier type for said calling party.

2. The method of claim 1, wherein said communication network is a Voice over Internet Protocol (VoIP) network.

3. The method of claim 1, wherein said service tier is determined by a measure of revenue derived from said calling party.

4. The method of claim 3, wherein if said derived revenue exceeds a predefined threshold, then said calling party is classified as a high service tier customer.

5. The method of claim 1, wherein said call setup message is received by the call control element (CCE).

6. The method of claim 4, wherein said processing comprises:
routing said call originated by said calling party to a live customer care agent if said calling party is determined to be said high service tier customer; or
presenting at least one promotional offer to said calling party via a network announcement before completing the processing of said call setup message if said calling party is determined to be said high service tier customer.

7. A computer-readable medium having stored thereon a plurality of instructions, the plurality of instructions including instructions which, when executed by a processor, cause the processor to perform the steps of a method for segmenting customers into service tiers in a communication network, comprising:
receiving a call setup message for a call from a calling party;
determining a service tier type for said calling party; and
processing said call setup message in accordance with said service tier type for said calling party.

8. The computer-readable medium of claim 7, wherein said communication network is a Voice over Internet Protocol (VoIP) network.

9. The computer-readable medium of claim 7, wherein said service tier is determined by a measure of revenue derived from said calling party.

10. The computer-readable medium of claim 9, wherein if said derived revenue exceeds a predefined threshold, then said calling party is classified as a high service tier customer.

11. The computer-readable medium of claim 7, wherein said call setup message is received by the call control element (CCE).

12. The computer-readable medium of claim 10, wherein said processing comprises:
routing said call originated by said calling party to a live customer care agent if said calling party is determined to be said high service tier customer; or
presenting at least one promotional offer to said calling party via a network announcement before completing the processing of said call setup message if said calling party is determined to be said high service tier customer.

13. A system for segmenting customers into service tiers in a communication network, comprising:
means for receiving a call setup message for a call from a calling party;
means for determining a service tier type for said calling party; and
means for processing said call setup message in accordance with said service tier type for said calling party.

14. The system of claim 13, wherein said communication network is a Voice over Internet Protocol (VoIP) network.

15. The system of claim 13, wherein said service tier is determined by a measure of revenue derived from said calling party.

16. The system of claim 15, wherein if said derived revenue exceeds a predefined threshold, then said calling party is classified as a high service tier customer.

17. The system of claim 13, wherein said call setup message is received by the call control element (CCE).

18. The system of claim 15, wherein said processing means comprises:
means for routing said call originated by said calling party to a live customer care agent if said calling party is determined to be said high service tier customer; or
means for presenting at least one promotional offer to said calling party via a network announcement before completing the processing of said call setup message if said calling party is determined to be said high service tier customer.
